(19) United States
(12) Patent Application Publication
(10) Pub. No.: US 2010/0239752 A1
(43) Pub. Date: Sep. 23, 2010

(54) Color Matching Test Piece and repair painting method

(75) Inventors: Junji Serizawa, Shizuoka (JP); Makoto Katsumata, Shizuoka (JP); Kiyokazu Otsuka, Saitama (JP)

Correspondence Address: WENDEROTH, LIND & PONACK, L.L.P., 1030 15th Street, N.W.,, Suite 400 East, Washington, DC, 20005-1503, US

(73) Assignee: AIOI Insurance Co., Ltd.

(21) Appl. No.: 12/308,575

(22) PCT Filed: Jun. 20, 2007
(86) PCT No.: PCT/JP2007/062458

§ 371 Date: Dec. 18, 2008

(30) Foreign Application Priority Data
Jun. 23, 2006 (JP) 2006-174664

(51) Int. Cl. B05D 3/00; G01N 21/25

(52) U.S. Cl. 427/140; 356/408

(57) ABSTRACT

This invention provides a color matching test piece capable of freely changing a combination of a base color and an upper color to be overpainted one on another with less work.

The color matching test piece 10 is formed of a clear-colorless film base 10a. A plurality of the color matching test pieces 10 painted with individual colors with respect to each color to be overpainted are prepared, and the test pieces 10 are stuck to a car body or the like with a defatting agent to reproduce the state of the overpainted color in order for color comparison relative to the original color of the car body. The color matching test piece 10 has peeling tabs 11 and jig holes 12 and is superposed on the other test pieces according to need. The superposed test pieces have peripheral surfaces other than the peeling tabs secured with one another by using adhesive 13 to form a lamination layer member 10b, so that the test pieces can be peeled off one by one from the uppermost test pieces by pinching and lifting the tabs 11 with fingers.

This invention relates to a color matching test piece and a repair painting method, and pertains to an effective technique applicable to repair painting or the like in, for instance, a process of repairing or remodeling a vehicle such as an automobile.

### BACKGROUND ART

As an example, the body color of vehicles such as an automobile is diversified according to users' tastes and others. Consequently, for retaining the commercial value of the repaired vehicle and maintaining and improving the visual appearance of the vehicle, it is vital that the color paints are blended to accurately reproduce the original body color of a car body having an injured portion to be removed so as to make the injured portion on the car body less noticeable compared with other portions of the car body.

In the process of blending paint to match an original color of the car body, a color matching test piece is prepared. To be specific, after painting the blended paint onto the test piece and drying, check whether the color of the paint applied onto the car body is identical to the original color of the car body is made by comparing the painted test piece with the original color.

As the foregoing test piece, there have hitherto been used paper, magnetic plate, tin plate or the like. Upon applying the blended paint for repair painting to the test piece, the color of the painted test piece is placed next to the car body to be compared to the original color (hereinafter referred to as “color comparison”). The processes of preparing the test piece and performing the color comparison have been repeated until the intended color is obtained.

However, there has been a technical problem that, when the painting color is made by combining a base color and an upper color in the conventional method as described above, it is necessarily required to apply the base color and upper color every time blending of the colors is reworked for other new test pieces, thus to require a huge amount of work for preparing the test piece.

Furthermore, since the test piece of magnetic material, tin plate or the like has low flexibility, it is disadvantageously difficult to curve the test piece exactly along the curved surface of the car body to be compared. Consequently, the test piece is not closely attached to the curved surface of the car body, thereby preventing comparative measurement of the original color of the car body and the color of the test piece in the same plane. The conventional method further has a technical problem such that the test piece has a shade therearound, thus to reduce the accuracy of color comparison.

Moreover, the test piece of a material other than magnetic material such as paper and tin plate cannot easily be fixed to the car body, thus to require troublesome chores to fix the test piece to the car body with an adhesive tape and observe the state of securing the test piece onto the car body while holding the test piece by a worker's hand. Consequently, the fixed test piece and the car body cannot be observed from a distance, thus to still reduce the accuracy of color comparison.

Meanwhile, the test piece made of magnetic material can easily be fixed to the curved surface of the car body, but there is concern that the magnetic force of the magnetic test piece possibly influences the distributed state of the paint particles in a paint solvent, likewise to prevent an accurate color comparison.

In either case, when the test piece of any of materials found in the conventional art is used, it is impossible to confirm the coloring number of times of overpainting paints on a repair portion properly to paint in match with a painting base on the repair portion (the number of times which the repair portion are overpainted with color paints until the painting base falls into complete obscurity). Therefore, a worker is often required to have a lot of skill to determine the number of times required for properly overpainting the repair portion with the color paints.

When the coloring number of times (overpainting number) is deficient, the repaired portion becomes conspicuous and is required to be overpainted again, consequently to suffer excessive losses of the paints and labor for painting.

Patent Literature 1 listed below discloses a conventional method of this type using color matching auxiliary cards, in which color samples having painting colors different in brightness and fixed in brightness by color mixture of white and black are placed in array on one sheet and applied with overcoating color paint to determine the color of the overcoating color paint.

However, Patent Literature 1 cannot resolve the technical problems as described above.

Patent Literature 1: Japanese published unexamined application No. 2002-371206

### DISCLOSURE OF THE INVENTION

### Problems to be Solved by the Invention

It is an object of the present invention to provide a color matching test piece capable of freely changing a combination of a base color and an upper color to be overpainted one on another with less work and a repair painting method using the same.

It is another object of the present invention to provide a color matching test piece capable of accurately performing a color comparison without being influenced by the surface configurations of various objects to be repaired by painting and a repair painting method using the same.

It is still another object of the present invention to provide a color matching test piece capable of determining the coloring number of times (overpainting number) based on the painting base and a repair painting method using the same.

### MEANS FOR SOLVING THE PROBLEMS

A color matching test piece as set forth in claim 1 of the present invention is featured by comprising clear-colorless flexible film bases laminated in a lamination layer member having peeling tabs, which lamination layer member has a peripheral surface other than the peeling tabs applied with clear-colorless adhesive and are peelable so that a worker can lift the tabs with fingers to peel the film bases layer by layer for a color matching test.

According to the invention, when overpainting different colors, the color matching test pieces prepared for the respective colors are superposed to reproduce the overpainted color for making a color comparison, thus to eliminate the need for repainting. As a result, a combination of a base color and an upper color to be overpainted can be freely changed with less work.

Furthermore, the flexible film bases of the invention can easily be attached to an object to be painted for repairing by using a solvent having no effect on painted layers such as a defatting agent, so that the painted color can be observed from an arbitrary distance for making the color comparison while bringing the color matching test piece into close contact with the surface configuration of the object. Consequently, an accurate measurement of the color comparison can be made without being influenced by the surface configurations of various objects to be repaired. Besides, the film base is transparent, so that the base color and other conditions of the repair portion of the object can be observed through the painted layers formed for repairing on the film base, thus to enable the number of overpainting to be determined as the number of times of overpainting when the base color on the repair portion is not diaphanous. Thus, the coloring number of times (overpainting number) based on the painting base and a repair painting method using the same can be determined without a lot of skill.

The color matching test pieces can be peeled layer by layer from the top downward. Thus, the color matching test piece of the invention is easy to handle, consequently to improve the workability of its own preparation.

As set forth in claim 2, the color matching test piece according to claim 1 is featured by further comprising a holding jig having a plate-like substrate for carrying the aforesaid film bases, a handle fixed to the aforesaid substrate, and film securing protrusions penetrating through the film bases in the thickness direction of the film bases.

According to this invention, a plurality of the color matching test pieces can be handled as a whole by being carried on the holding jig. A worker can apply paint to the color matching test piece by holding the handle of the holding jig by one hand while handling a paint spray gun by the other hand. Thus, the workability of preparing the color matching test pieces can be elevated.

As set forth in claim 3, the color matching test piece according to claim 1 or claim 2 is featured by having a plurality of the color matching test pieces individually painted with first painting color and second painting color to be overpainted on a repair painting area of an object to be repaired, superposing the color matching test pieces one on top of the other in the order of overpainting, and sticking the color matching test pieces thus superposed to the aforesaid repair portion in use.

According to the invention, in overpainting paint for upper color on paint for base color, a color comparison can be performed with less work only by remaking the color matching test piece for the upper color without remaking the color matching test piece for the base color.

As set forth in claim 4, the color matching test piece according to claim 3 is featured in which the aforesaid first painting color corresponds to the base color, and the aforesaid second painting color corresponds to the upper color.

According to the invention, even when a false color is necessary for the base color, a combination of the base color and the upper color can easily be confirmed without great labor merely by remaking the color matching test piece for the upper color.

As set forth in claim 5 and claim 6, the color matching test piece according to claim 3 or claim 4 is featured in which the aforesaid first painting color is a base color of tri-coat pearl, and the aforesaid second painting color is a pearl color of tri-coat pearl.

According to the invention, a color comparison for repair painting using the tri-coat pearl can be performed easily and color comparison.

As set forth in claim 7 and claim 8, the color matching test piece according to any of claim 3 to claim 6 is featured by using a clear-colorless defatting agent for attaching the aforesaid color matching test piece onto the repair painting area or superposing the color matching test pieces one on top of the other.

According to the invention, an accurate measurement of the color comparison can be made by bringing the whole surface of the color matching test piece into close contact with the repair portion of the object using the defatting agent having no influence on the painted layer.

As set forth in claim 9, a repair painting method according to the invention is featured by comprising a first step of preparing a repair object to be repaired with paints, a second step of preparing repairing paint, a third step of preparing color matching test pieces by applying the repairing paints to a clear-colorless flexible film base, and a fourth step of sticking the aforesaid color matching test piece to a repair painting area of the repair object, wherein the first color matching test piece applied with a paint for a base color and the second color matching test piece applied with a paint for an upper color are prepared in the aforesaid third step, and the aforesaid first and second color matching test pieces are stuck to the aforesaid repair painting area of the repair object with the aforesaid first and second color matching test pieces superposed using a defatting agent in the aforesaid fourth step.

According to the invention, when overpainting different colors, the color matching test pieces prepared for the respective colors are superposed to reproduce the overpainted color for making a color comparison, thus to eliminate the need for repainting. As a result, a combination of a base color and an upper color to be overpainted can be freely changed with less work.

Furthermore, the flexible film bases of the invention makes it possible to observe the painted color from an arbitrary distance for making the color comparison while bringing the color matching test piece into close contact with the surface configuration of the object. Consequently, an accurate measurement of the color comparison can be made without being influenced by the surface configurations of various objects to be repaired.

Besides, the film base is transparent, so that the base color and other conditions of the repair portion of the object can be observed through the painted layers formed for repairing on the film base, thus to enable the number of times of overpainting to be determined as the number of times of overpainting when the base color on the repair portion is not diaphanous. Thus, the coloring number of times (overpainting number) based on the painting base and a repair painting method using the same can be determined without a lot of skill.

According to the invention, in overpainting paint for upper color on paint for base color, a color comparison can be performed with less work only by remaking the color matching test piece for the upper color without remaking the color matching test piece for the base color.

As set forth in claim 10, a repair painting method according to the invention is featured by comprising a first step of preparing a repair object to be repaired with paints, a second step of preparing repairing paint, a third step of preparing color matching test pieces by applying the repairing paints to a clear-colorless flexible film base, a fourth step of sticking the aforesaid color matching test piece to a repair painting area of the repair object, a fifth step of comparing the color of the aforesaid color matching test piece stuck to the repair painting area with an original painting color around the repair painting area of the aforesaid repair object, and a sixth step of determining whether the aforesaid repair painting area is diaphanous or not through the aforesaid color matching test piece stuck to the repair painting area, wherein the process in the aforesaid fifth step is stepped back to the aforesaid second step to reprepare the aforesaid repairing paint and perform the aforesaid third step for applying the repair paint to another color matching test piece when determining that the color of the aforesaid color matching test piece is different from the aforesaid original painting color around the repair painting area of the aforesaid repair object, and the process in the aforesaid sixth step is stepped back to the aforesaid third step to have the aforesaid color matching test piece overpainted with the aforesaid repairing paint to increase the number of times of overpainting when determining that the aforesaid repair painting area is diaphanous through the aforesaid color matching test piece stuck to the repair painting area.

According to the invention, correct color matching can be accomplished by individually determining color identity of the original painting color with the painting color painted on the repair painting area and excess or deficiency of the number of times of overpainting.

### EFFECT OF THE INVENTION

The present invention can provide a color matching test piece capable of freely changing a combination of a base color and an upper color to be overpainted one on another with less work and a repair painting method using the same.

Further, the present invention can provide a color matching test piece capable of accurately performing a color comparison without being influenced by the surface configurations of various objects to be repaired by painting and a repair painting method using the same.

Further, the present invention can provide a color matching test piece capable of determining the coloring number of times (overpainting number) based on the painting base and a repair painting method using the same.

### BRIEF DESCRIPTION OF THE DRAWINGS

FIG. 1 is a perspective view showing one embodiment of the color matching test piece according to the present invention.

FIG. 2 is a perspective view showing a holding jig for handling the color matching test piece according to the embodiment of the invention.

FIG. 3 is a flowchart illustrating the operation of the color matching test piece in the repair painting method according to the embodiment of the invention.

FIG. 4 is an explanatory view illustrating the repair painting method using the color matching test piece according to the embodiment of the invention.

FIG. 5 is another explanatory view illustrating the repair painting method using the color matching test piece according to the embodiment of the invention.

FIG. 6 is still another explanatory view illustrating the repair painting method using the color matching test piece according to the embodiment of the invention.

FIG. 7 is a further explanatory view illustrating the repair painting method using the color matching test piece according to the embodiment of the invention.

FIG. 8 is the other explanatory view illustrating the repair painting method using the color matching test piece according to the embodiment of the invention.

FIG. 9 is the other explanatory view illustrating the repair painting method using the color matching test piece according to the embodiment of the invention.

FIG. 10 is the other explanatory view illustrating the repair painting method using the color matching test piece according to the embodiment of the invention.

FIG. 11 is the other explanatory view illustrating the repair painting method using the color matching test piece according to the embodiment of the invention.

FIG. 12 is the other explanatory view illustrating the repair painting method using the color matching test piece according to the embodiment of the invention.

FIG. 13 is the other explanatory view illustrating the repair painting method using the color matching test piece according to the embodiment of the invention.

FIG. 14 is the other explanatory view illustrating the repair painting method using the color matching test piece according to the embodiment of the invention.

FIG. 15 is an explanatory view illustrating the repair painting method using the color matching test piece according to a modified embodiment of the invention.

FIG. 16 is another explanatory view illustrating the repair painting method using the color matching test piece according to the modified embodiment of the invention.

FIG. 17 is still another explanatory view illustrating the repair painting method using the color matching test piece according to the modified embodiment of the invention.

FIG. 18 is a further another explanatory view illustrating the repair painting method using the color matching test piece according to the modified embodiment of the invention.

FIG. 19 is the other explanatory view illustrating the repair painting method using the color matching test piece according to the modified embodiment of the invention.

### EXPLANATION OF REFERENCE MARKS

10 Color matching test piece

10-1 Color matching test piece

10-2 Color matching test piece

10-3 Color matching test piece

10a Film base

10b Lamination layer member

11 Tabs

12 Jig hole

13 Adhesive

14 Substrate

15 Handle

16 Film securing protrusion

17 Holding jig

21 Undercoating paint

22 Overcoating paint

31 White paint

32 Pearl color paint

100 Door panel

101 Repair portion

102 Base paint

103 Original painting portion

200 Masking member

300 Spray gun

400 Defatting agent spray gun

401 Defatting agent

### BEST MODE FOR CARRYING OUT THE INVENTION

Embodiments of the present invention will be described hereinafter in detail with reference to the accompanying drawings.

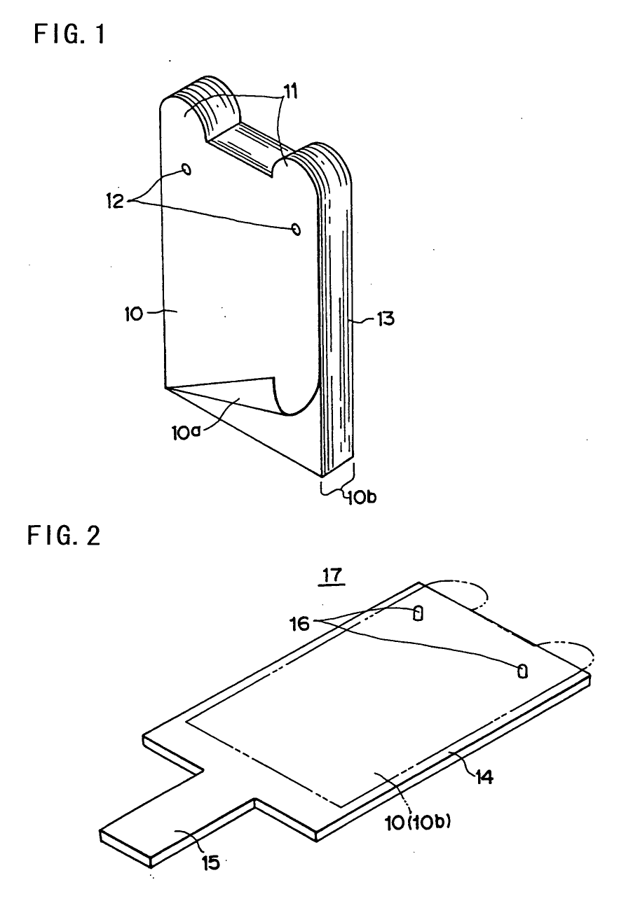

FIG. 1 is a perspective view showing one embodiment of a color matching test piece according to the present invention, and FIG. 2 is a perspective view showing a holding jig for handling the color matching test piece according to the embodiment of the invention.

As exemplified in FIG. 1, the color matching test piece 10 according to one embodiment of the invention is formed of a rectangular film base 10a such as of a polyethylene film.

The film base 10a is clear and colorless and has a thickness of 10 to 100 micrometers, preferably, about 30 micrometers. Thus, the color matching test piece 10 formed of the film base 10a has sufficient flexibility and strength.

The rectangular color matching test piece 10 is provided with a pair of tabs 11 on both sides of one of the short sides thereof, so that a worker can easily pick up the color matching test piece 10 with his fingers or any other tool.

Near the tabs 11 of the color matching test piece 10, a pair of jig holes 12 are formed so as to insert film securing protrusions 16 on a holding jig 17 as described later thereinto.

In this embodiment, a plurality of the color matching test pieces 10 are superposed to form a lamination layer member 10b. To the peripheral surface portion of the lamination layer member 10b other than the tabs 11, adhesive 13 is applied, so that a plurality of the color matching test pieces can be handled as a whole.

As one example, the worker can use the color matching test pieces one by one by peeling off the laminated layer 10b while pinching the tabs 11 with his fingers.

Meanwhile, as illustrated in FIG. 2, a holding jig 17 for use in handling the color matching test piece 10 comprises a substrate 14 for carrying the color matching test piece 10, a handle 15 formed at one end of the substrate 14, and a pair of film securing protrusions 16 formed on the substrate 14 on the opposite side to the handle 15.

In this embodiment, the lamination layer member 10b of the color matching test piece 10 can be retained on the substrate 14 by fitting the film securing protrusions 16 into jig holes 12 bored in the lamination layer member 10b of the color matching test piece 10.

As one example, the color matching test piece 10 prepared by painting the clear-colorless film substrate 10a with a testing paint of an arbitrary color can be produced with good workability by holding the handle 15 of the holding jig 17 by one hand while handling a paint spray gun 300 by the other hand.

By peeling off the color matching test piece 10 applied with the testing paint from the lamination layer member 10b, another color matching test piece 10 appears from the underside of the peeled color matching test piece, so that the next test painting can be performed.

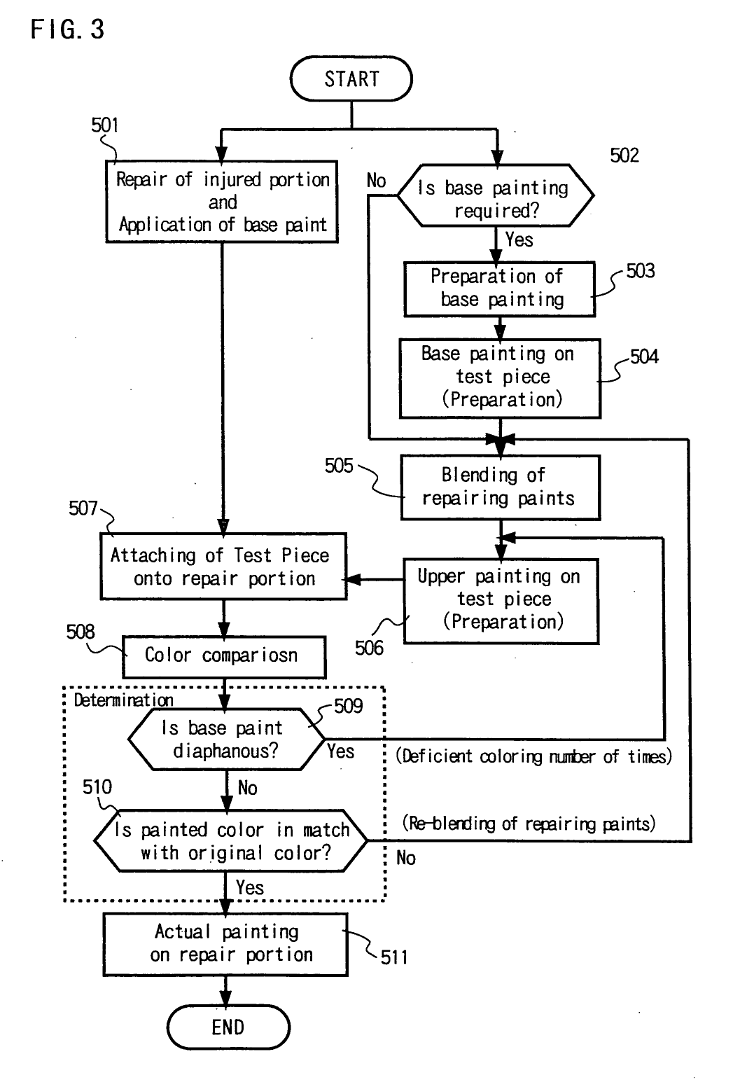

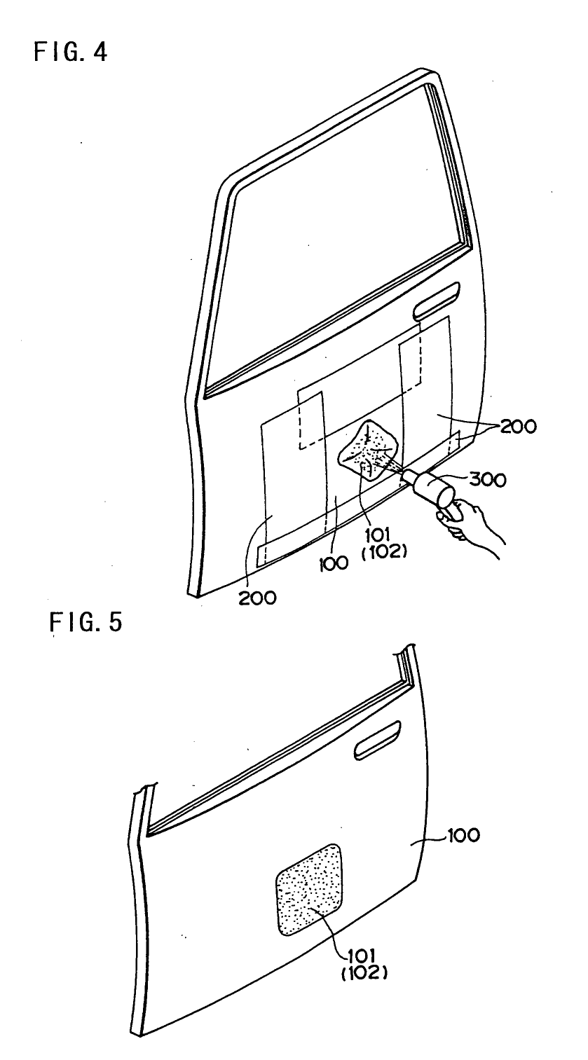

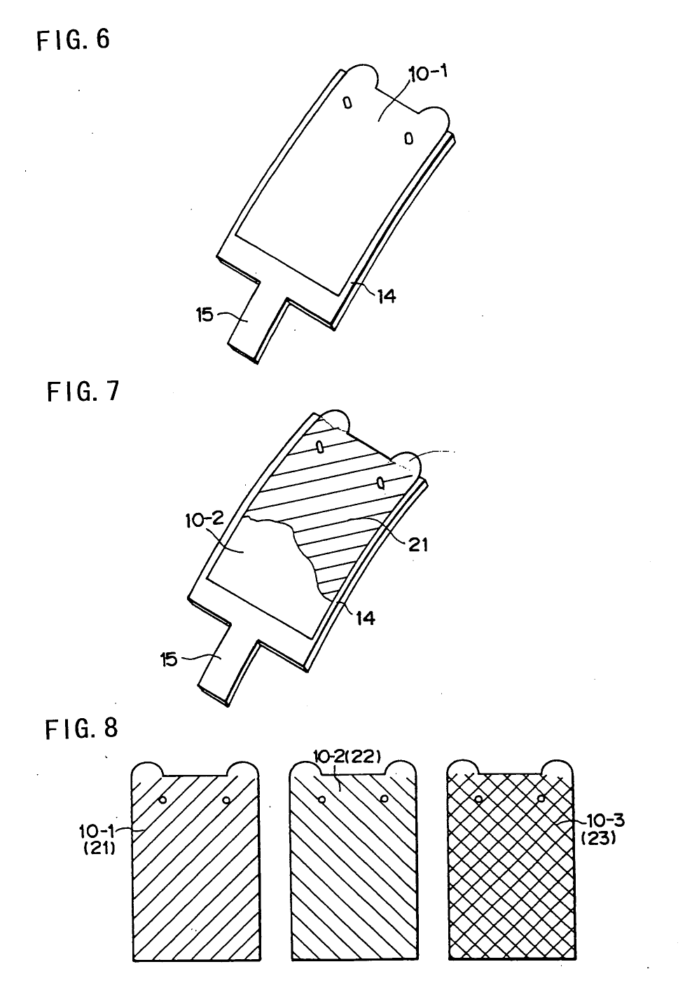

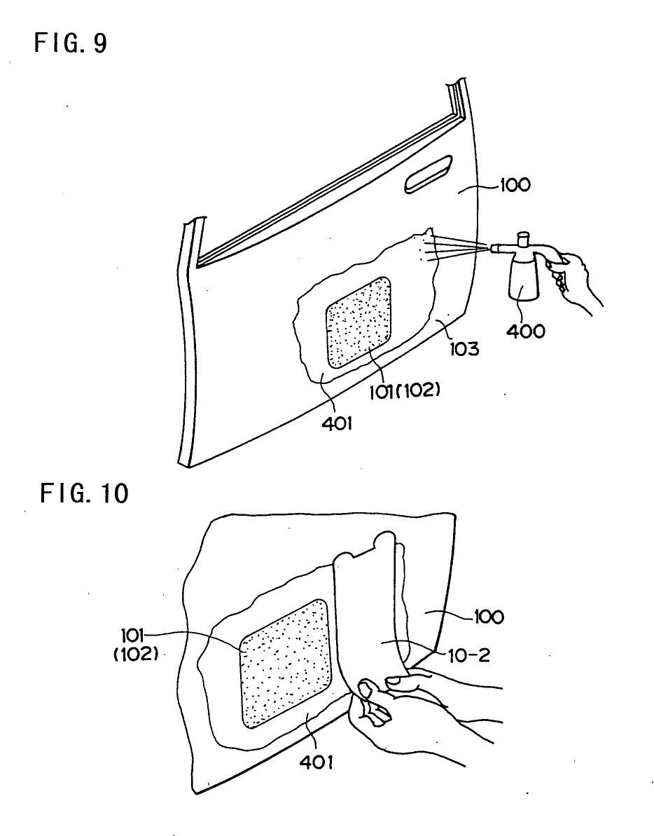

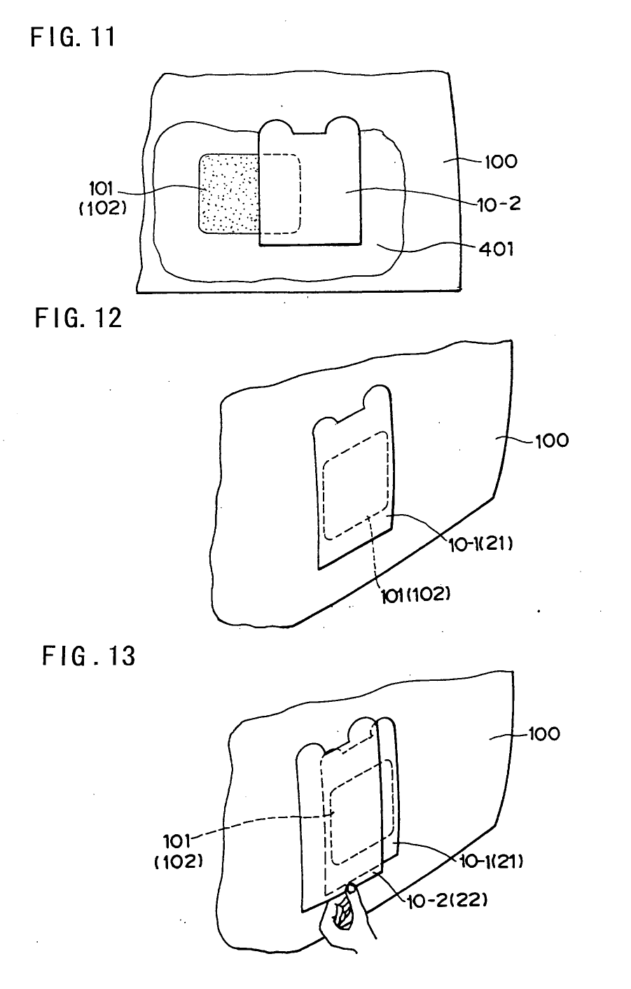

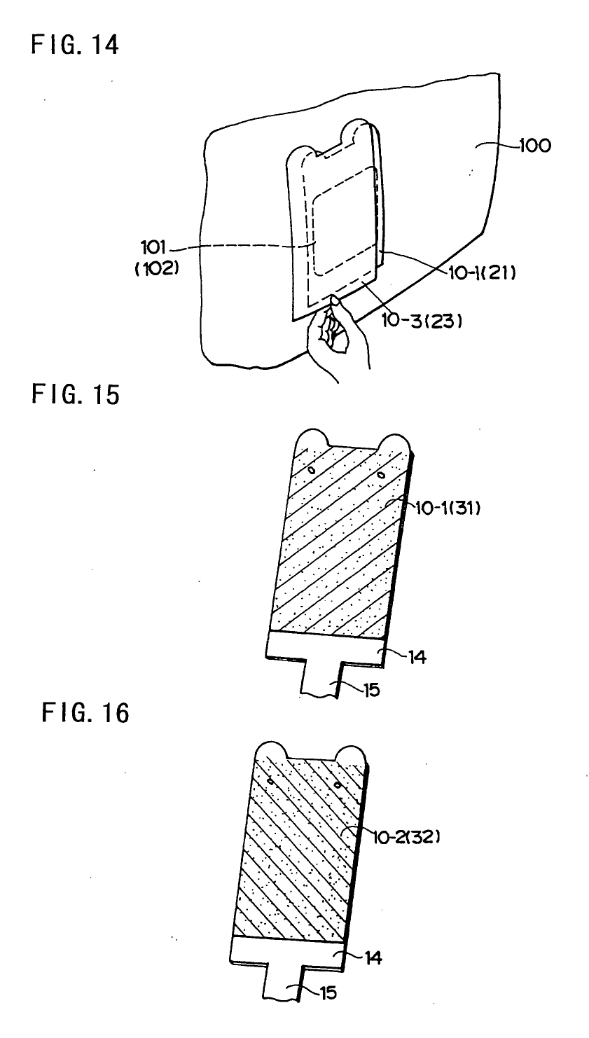

Next, one example of a repair painting process using the color matching test piece 10 according to the embodiment of the invention will be described with reference to a flowchart of FIG. 3 and process charts of FIG. 4, FIG. 5, FIG. 6, FIG. 7, FIG. 8, FIG. 9, FIG. 10, FIG. 11, FIG. 12, FIG. 13 and FIG. 14.

Here, there will be explained the embodiment of the invention applied for repair painting to repair a damaged part (repair portion 101) in the center of a door panel 100 of a car.

First, as illustrated in FIG. 4, an area other than the repair portion 101 of the door panel 100 as a repairing object to be repaired is concealed with a masking member 200, and then, the repair portion 101 exposed out of the masking member 200 is painted by being sprayed with a base paint 102 by using a spray gun 300.

The base paint 102 is a so-called “primer surfacer”, which has a combination of a function of a primer to be painted for enhancing adherability relative to the base material (steel plate of the door panel 100 in this embodiment) and a function of a surfacer to be painted for conditioning the surface of the painting base.

After applying the base paint 102, the masking member 200 is removed from the door panel 100 as shown in FIG. 5, and then, application of painting on the door panel is completed when the base paint 102 thus applied is dried (Step 501).

Meanwhile, before, after or in tandem with Step 501, the paint used for the repair painting is prepared.

That is, when undercoating is necessary for repair painting according to need (Step 502), paint for undercoating (undercoating paint 21 in this embodiment) is prepared by measuring paints specified in blend weight according to color data and blending the paints (Step 503). Then, the color matching test piece 10-1 is prepared by applying the prepared undercoating paint 21 (base color) under the same conditions as the actual repair painting as shown in FIG. 6 (Step 504).

In the same manner, an overcoating paint 22 is prepared by measuring paints specified in blend weight according to color data and blending the paints (Step 505). Then, the color matching test piece 10-2 is prepared by applying the prepared overcoating paint 22 (upper color) as many as the number of times the repair painting is intended to be repeated, as shown in FIG. 7 (Step 506).

The assumed repair painting using superposition of the undercoating paint 21 and overcoating paint 22 will be described below.

A color having high color saturation (transparency) such as red color makes it impossible to color the color matching test piece unless a paint of such a color is applied a number of times (more than 10 times), so overcoating is usually carried out for repair painting after applying a paint of pseudo color (base color). Sometimes the base color is specified in some colors. In this case, overpainting with the undercoating paint 21 and overcoating paint 22 is required.

In the embodiment of the invention, in the case where the overpainting is performed using the undercoating paint 21 and overcoating paint 22 for repair painting as shown in FIG. 8, the color matching test piece 10-1 and color matching test piece 10-2 are prepared respectively for the undercoating paint 21 and overcoating paint 22.

In FIG. 8, the color matching test piece 10-3 prepared under different conditions including the number of times of overpainting the overcoating paint 22 when the color matching test piece 10-2 for the overcoating paint 22 is determined as insufficient is illustrated in juxtaposition.

When the color matching test piece 10-1 for the undercoating paint 21 and the color matching test piece 10-2 for the undercoating paint 21 are prepared in the aforementioned manner, the color matching test piece 10 is stuck to the door panel 100 in the manner as described below (Step 507).

In a case of single color (when repair painting is carried out only with the overcoating paint 22 without using the undercoating paint 21), color comparison to determine whether the color of the color matching test piece 10-2 is in match with the color of the original painting portion 103 therearound is carried out by applying a defatting agent 401 or a clear-colorless solvent having no influence on the painted layer to the door panel 100 by using a defatting agent spray gun 400 as an adhesive, and then, bringing the color matching test piece 10-2 prepared by using the overcoating paint 22 in close contact therewith (Step 507) (cf. FIG. 10).

The defatting agent 401 in this embodiment is commonly used for usual repair painting and has the advantage of requiring no specific adhesive or the lie for sticking the color matching test piece 10 to the door panel 100.

At this time, a conventionally used paper test piece has no means to be stuck to a painting object and therefore has need of an adhesive tape. On the other hand, the embodiment according to the present invention has an advantage in that the color matching test piece 10-2 formed of the flexible film base 10a is closely stuck to the painting object through the defatting agent 401, so that color comparison can easily be effected for the door panel 100 in any shape or form.

Furthermore, the color matching test piece 10-1 and color matching test piece 10-2 can be attached firmly to the door panel 100 without disengaging from the door panel and make no shadow therearound, thus to enable an accurate color comparison in the same plane relative to the original painting portion 103 around the repair portion.

As shown in FIG. 11, confirmation on the number of times (overpainting number N) to overpaint with the undercoating paint 21 for the purpose of coloring the base paint 102 of the repair portion 101 into an intended color (e.g. red) of the original painting portion 103 can be accomplished while executing color matching by placing the color matching test piece 10-2 on halves on the repair portion 101 applied with the base paint 102 and the original painting portion 103 around the repair portion.

The color comparison in superposition of the undercoating paint 21 and overcoating paint 22 is made in the manner as described below.

In this case, the color matching test piece 10-1 first prepared with the undercoating paint 21 by using the defatting agent 401 is closely attached to the door panel 100 (cf. FIG. 12), and on top thereof, the color matching test piece 10-2 is closely attached by using the defatting agent spray gun 400 (cf. FIG. 13) (Step 507).

Thus, the state of overpainting on the door panel 100 can be reproduced from the state of overpainting the undercoating paint 21 and overcoating paint 22 by using the color matching test piece 10-1 and color matching test piece 10-2, so that the color comparison in superposition of the undercoating and overcoating paints with the original painting portion 103 around the repair portion (Step 508).

It is possible for the worker to observe the portion to be subjected to the color comparison from a distance without holding the color matching test piece 10-1 and color matching test piece 10-2 by hand.

In this case, as shown in FIG. 14, the respective halves of the color matching test piece 10-1 and color matching test piece 10-2 are superposed on the base paint 102 of the repair portion 101, so that confirmation on ‘coloring degree’ of the base paint 102 (appropriateness of the number of times N of overpainting with the overcoating paint 22) can be confirmed.

Next, there is made confirmation on whether the base paint 102 is diaphanous or not through the color matching test piece 10-2 for the overcoating paint 22 (in a case of a single color) or the color matching test piece 10-1 for the undercoating paint 21 and the color matching test piece 10-2 (in a case of overpainting) (Step 509). In a case of insufficient ‘coloring degree’ (shortage of the overpainting number of times N of overpainting with the overcoating paint 22), the color matching test piece 10-3 having the increased number of times N of overpainting with the overcoating paint 22 is prepared (cf. FIG. 8), and then, the color comparison is again performed with the color matching test piece 10-1 superposed thereon.

In this connection, the conventional method had to repeat the painting using the undercoating paint 21 and overcoating paint 22 every time the test piece is prepared.

However, according to the embodiment of the invention, the color matching test piece 10-1 can be used as is by preparing only the color matching test piece 10-3 changed in the number of times N of overpainting the overcoating paint 22. Consequently, the embodiment of the invention can significantly reduce the labor and time required for preparing the color matching test piece 10.

Discrimination on whether the color of the color matching test piece 10-2 for the overcoating paint 22 (in a case of a single color) or the color matching test piece 10-1 for the undercoating paint 21 and the color matching test piece 10-2 for the overcoating paint 22 (in a case of overpainting) are in match with the color of the original painting portion 103 around the painting portion is exercised (Step 510). When they are in discord with the original color, this process is stepped back to Step 505 to reprepare the overcoating paint 22, so that the color matching test piece 10-2 painted with another overcoating paint 22 is prepared for making color comparison.

The order of discriminating the colors in the aforementioned Step 509 and Step 510 is expediential and may change arbitrarily.

Hence, the base paint 102 has the ‘coloring degree’ well-matched with the overcoating paint 22 (color matching test piece 10-2) or the undercoating paint 21 (color matching test piece 10-1) and overcoating paint 22 (color matching test piece 10-2). Besides, in the case where the base paint 102 having ‘coloring degree’ well-matched with the overcoating paint 22 (color matching test piece 10-2) or the undercoating paint 21 (color matching test piece 10-1) and overcoating paint 22 (color matching test piece 10-2) are in match with the color of the original painting portion 103 around the painting portion, the intended conditions for repair painting is accounted to be accomplished, so that only the overcoating paint 22 or the undercoating paint 21 and overcoating paint 22 are applied to the entire surface of the door panel 100. (Step 511).

Thus, the base paint 102 of the repair portion 101 applied can be made diaphanous in the door panel 100. Further, the repair painting is carried out under the condition that the painted color is in match with the color of the original painting portion 103, thus to enable accurate repair beyond recognition compared to the original state before repairing.

As is apparent from the foregoing description, the embodiment of the invention brings about desirable effects as described below.

As the present invention enables observation on whether the base paint 102 is diaphanous or not through the color matching test piece 10-2 or the superposed color matching test piece 10-1 and color matching test piece 10-2, the coloring number of times, i.e. the number of times N of appropriately overpainting the overcoating paint 22 can be confirmed.

Consequently, the number of times of retrying of repair painting for the door panel 100, which is inevitably required due to the number of times N of inadequately overpainting with the test piece, can be decreased thus to reduce the cost of repair painting and shorten working hours of repair painting.

In a case of performing the repair painting by overpainting with the undercoating paint 21 and overcoating paint 22, the color matching test piece 10-1 for the undercoating paint 21 can be repeatedly used as is, so the color matching test piece 10-2 for he overcoating paint 22 has only be reprepared, thus to enable color matching without applying the undercoating paint 21 (base color) to the color matching test piece each time.

As the color matching test piece 10 is formed of thin, flexible film base 10a, so that the it can easily be stuck steadily to the door panel 100 through a solvent, a defatting agent 401 or the like, it requires no fixing means such as an adhesive tap for sticking the test piece to the car body (door panel 100) and no troublesome work to hold the test piece by hand, thus to make work required for color comparison easy.

As the color matching test piece 10 is formed of thin, flexible film base 10a, the color matching test piece 10 can be made flash with the curved surface of the car body (door panel 100) having a completed surface configuration, thus to make work required for color comparison easy.

Next, another embodiment for repair painting in a manner using tri-coat pearl paints for overpainted base color and upper color will be described. The tri-coat pearl painting is performed by superposing the upper color is a pearl color (for example, pearl mica) on the base color (foundation color) and further superposing a clear paint thereon to form a three-layer structure. In performing the repair painting, the uppermost clear paint is transparent to make a color matching process unnecessary, but the color comparison of the base color paint with the pearl mica color as the upper color superposed on the base color paint has to be made.

The color comparison in a case of using a white paint 31 as the base color and a pearl paint 32 as the upper color will be described hereinafter.

As shown in FIG. 15, a color matching test piece 10-1 is prepared by first applying the white paint 31 as the base color to a color matching test piece 10 (Process 1).

As shown in FIG. 16, a color matching test piece 10-2 is prepared by applying the pearl paint 32 as the upper color separately from the color matching test piece 10-1 (Process 2).

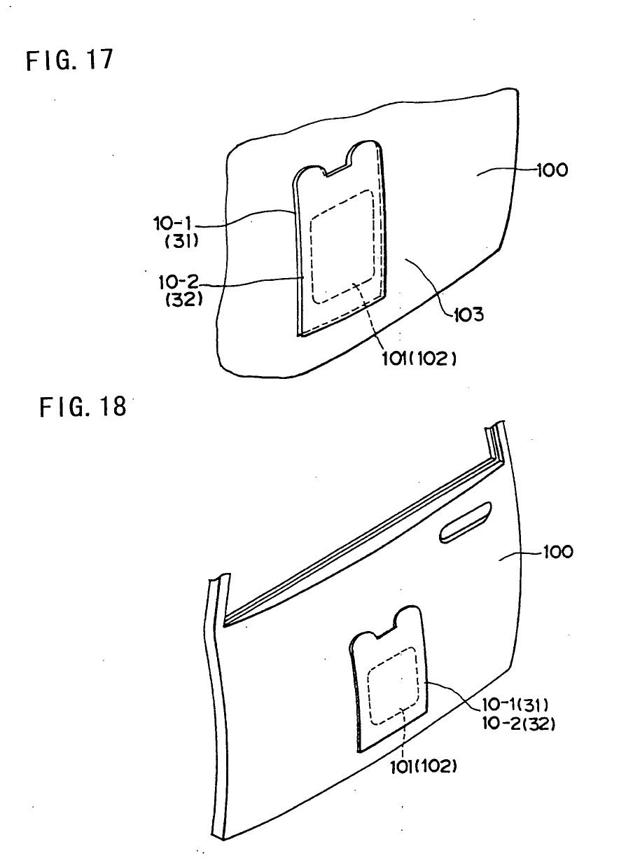

As shown in FIG. 17, the color matching test piece 10-2 prepared in Process 2 is superposed on the color matching test piece 10-1 prepared in Process 1, and the superposed test pieces thus obtained is stuck to the car body (door panel 100) (Process 3).

A clear solvent such as the aforementioned defatting agent 401 is applied into between the door panel 100 and the color matching test piece 10-1 and between the color matching test piece 10-1 and the color matching test piece 10-2, and then, these test pieces are superposed on the door panel.

Therefore, as shown in FIG. 18, color viewed through the superposed color matching test pieces 10-1 and 10-2 is compared with the color of the original painting portion 103 therearound (Process 4).

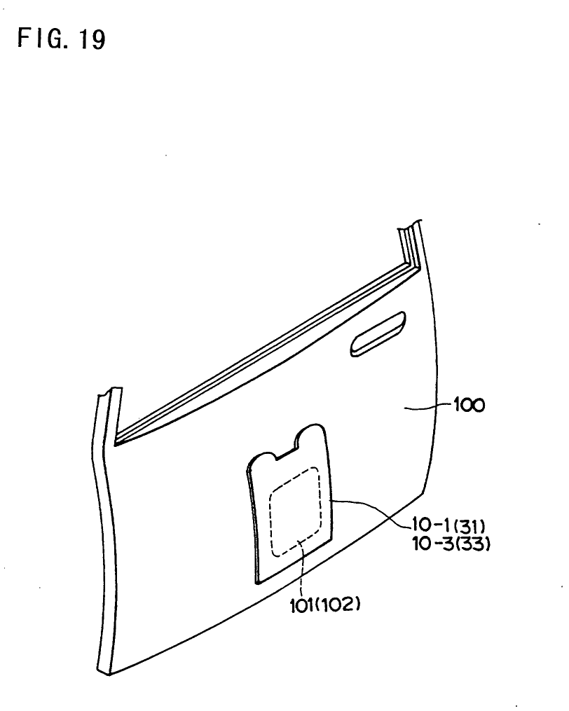

When the color viewed through the superposed color matching test pieces 10-1 and 10-2 is not matched with that of the original painting portion 103, the processes of Process 1, Process 2 and Process 3, the processes of Process 1 and Process 3 or the processes of Process 2 and Process 3 are performed after finely adjusting the white paint 31 and/or pearl paint 32. When one of the white paint 31 and pearl paint 32 is finely adjusted, it is only necessary to apply the finely adjusted paint to the color matching test piece 10-1 or the color matching test piece 10-2 (FIG. 19).

Hence, the color matching test piece 10-1 and the color matching test piece 10-2, which are formed of the clear film base 10a and individually painted with the white paint 31 or the pearl paint 32 are used respectively, so that the base color (white paint 31) and the upper color (pearl paint 32) can variedly be combined to obtain a variety of colors adaptable for color comparison. Thus, since it is unnecessary for the present invention to repaint one obscure test piece with the white paint 31 and pearl paint 32 each time as was conventionally performed, the amount of time required for preparing the color matching test piece 10 and performing the color comparison and repair painting can be shortened.

Moreover, the embodiment of the present invention enables confirmation on the number of times of coloring and eliminate the need for fixing means such as an adhesive tap for sticking the test piece 10 to the car body so as to make the color comparison easy. Further, the present invention possesses an advantage of making the color matching test piece 10 flash with the curved surface of the car body, thus to make work required for color comparison easy, similarly to the embodiment using the aforementioned base paint 21 and the upper paint 22.

Although the present invention has been described in its preferred forms with a certain degree of particularity, it is understood that the present disclosure of the preferred forms has been modified in the details of construction and the combination and arrangement of elements may be resorted to without departing from the scope of the invention as hereinafter claimed.

### INDUSTRIAL APPLICABILITY

The color matching test piece and repair painting method according to the present invention are applicable to repair painting or the like in a process of repairing or remodeling a vehicle such as an automobile and can freely change a combination of the base color and upper color with less work when overpainting different colors. Further, the invention makes it possible to accurately perform a color comparison without being influenced by the surface configurations of various objects to be repaired by painting and a repair painting method using the same and appropriately determine the coloring number of times based on the painting base.

1. A color matching test piece formed of clear-colorless flexible film bases, wherein said film bases are laminated in a lamination layer member having peeling tabs, said lamination layer member having a peripheral surface other than said peeling tabs applied with clear-colorless adhesive and being peelable so as to permit said film bases to be peeled off layer by layer for use in a color matching test by lifting said tabs with fingers.

2. The color matching test piece set forth in claim 1, further comprising a holding jig having a plate-like substrate for carrying said film bases, a handle fixed to said substrate, and film securing protrusions penetrating through said film bases in the thickness direction of said film bases.

3. The color matching test piece set forth in claim 1, featured by having a plurality of said color matching test pieces individually painted with first painting color and second painting color to be overpainted on a repair painting area of an object to be repaired, superposing said color matching test pieces one on top of the other in the order of overpainting, and sticking said color matching test pieces to said repair portion in use.

4. The color matching test piece set forth in claim 3, wherein said first painting color corresponds to said base color, and said second painting color corresponds to said upper color.

5. The color matching test piece set forth in claim 3, wherein said first painting color is a base color of tri-coat pearl, and said second painting color is a pearl color of tri-coat pearl.

6. The color matching test piece set forth in claim 4, wherein said first painting color is a base color of tri-coat pearl, and said second painting color is a pearl color of tri-coat pearl.

7. The color matching test piece set forth in claim 3, featured by using a clear-colorless defatting agent for attaching said color matching test piece onto the repair painting area or superposing said color matching test pieces one on top of the other.

8. The color matching test piece set forth in claim 4, featured by using a clear-colorless defatting agent for attaching said color matching test piece onto the repair painting area or superposing said color matching test pieces one on top of the other.

9. A repair painting method comprising a first step of preparing a repair object to be repaired with paints, a second step of preparing repairing paint, a third step of preparing color matching test pieces by applying said repairing paints to a clear-colorless flexible film base, and a fourth step of sticking said color matching test piece to a repair painting area of said repair object, wherein said first color matching test piece applied with a paint for a base color and said second color matching test piece applied with a paint for an upper color are prepared in said third step, and said first and second color matching test pieces are stuck to said repair painting area of the repair object with said first and second color matching test pieces superposed using a defatting agent in said fourth step.

10. A repair painting method comprising a first step of preparing a repair object to be repaired with paints, a second step of preparing repairing paint, a third step of preparing color matching test pieces by applying said repairing paints to a clear-colorless flexible film base, a fourth step of sticking said color matching test piece to a repair painting area of said repair object, a fifth step of comparing the color of said color matching test piece stuck to the repair painting area with an original painting color around said repair painting area of said repair object, and a sixth step of determining whether said repair painting area is diaphanous or not through said color matching test piece stuck to said repair painting area,
wherein the process in said fifth step is stepped back to said second step to reprepare said repairing paint and perform said third step for applying said repair paint to another color matching test piece when determining that the color of said color matching test piece is different from said original painting color around said repair painting area of said repair object, and the process in said sixth step is stepped back to said third step to have said color matching test piece overpainted with said repairing paint to increase the number of times of overpainting when determining that said repair painting area is diaphanous through said color matching test piece stuck to said repair painting area.
